(19) United States
(12) Patent Application Publication
(10) Pub. No.: US 2003/0050794 A1
(43) Pub. Date: Mar. 13, 2003

(54) Hospital emergency department resource utilization and optimization system

(76) Inventor: Marjorie Keck, Lakeland, FL (US)

Correspondence Address: VAN DYKE & ASSOCIATES, P.A., 7200 LAKE ELLENOR DRIVE, SUITE 252, ORLANDO, FL, 32809, US

(21) Appl. No.: 09/949,211

(22) Filed: Sep. 7, 2001

(51) Int. Cl. G06F 17/60

(52) U.S. Cl. 705/2

(57) ABSTRACT

A method and system for tracking the provision of hospital care, ensure efficient utilization of hospital resources and optimize reimbursement of hospital expenditures keyed to insurance company policies is disclosed. The system allows hospital administrators to monitor the cumulative activity of a given department over a time period and assess staff and administrative efficiency. In a preferred embodiment the system enables a user to define patient care parameters in a flowsheet format, track patient, physician, and other medical personnel activity from admission through discharge, and statistically analyze data from a given time period to increase hospital efficiency and optimize reimbursement by insurance companies.

### FIELD OF THE INVENTION

The present invention relates generally to a method for using a computer software system for streamlining the tracking and provision of hospital care and optimizing reimbursement of hospital expenditures keyed to insurance company policies. While this method has nearly universal application within varying departmental hospital environments, a number of features of the present invention are optimized for use within a hospital's Emergency Department facility.

### BACKGROUND

The United States ranks first in the world in per-capita health care expenditures. With close to 80 percent of the over 90 million annual Emergency Department visits paid for by some form of private or government insurance, proper reimbursement plays a critical role in the long term survival of any hospital. (National Center for Health Statistics, Advance Data, Dec. 12, 1997 (Vol. 293)). At a time when national health care costs continue to escalate at an alarming rate, managed-care companies and the government have been successful in holding down payments to hospitals. (Kuftner, 1999) The average net profit margin of hospitals in 1998 was unchanged from the previous year, at about 5 percent, and it could well decline in coming years. (Kuttner, 1999) To survive financially, hospital administrators have been forced to develop novel means of ensuring that their hospital is properly compensated for all services rendered. Today, the provision of medical care or admission to a hospital often assumes a subordinate role to the collection of an extensive amount of patient information. Hospital administrators often need to maintain significant quantities of patient data such as admission, medical history, insurance, and billing information. Proper reimbursement from insurance companies is absolutely essential if hospitals are to meet the ever increasing financial demands of providing high quality health care to patients. The unique, often hectic nature of hospital Emergency Room departments present complicated problems for hospital administrators.

Working under highly stressful conditions, emergency medical staff are routinely forced to balance administrative tasks, while attending to multiple patients suffering from severe injuries. Often, patients arrive in an Emergency Department unconscious with reduced communicative abilities as to their identity, with life threatening injuries that require immediate medical attention. An attending Physician may issue an array of orders ranging from X-rays, to medication administration, to laboratory assays, all of which must be tracked and recorded to insure proper billing and reimbursement. In these situations, it is unacceptable to interfere with the administration of care in order to obtain patient medical care, or resource utilization data. Often, information routinely collected prior to admission may not be properly recorded until some time after the patient has been stabilized. As a result, it is not uncommon for a hospital to provide expensive care to a patient without obtaining adequate information to ensure proper compensation from the patient's insurance company. At a time when administrative health care costs continue rise, and insurance payments continue to drop, it is imperative that hospital administrators find new ways to streamline the provision and quality of healthcare, while at the same time optimizing the likelihood of proper reimbursement of hospital expenditures keyed to insurance company policies. Furthermore, to remain viable and competitive, it is critical for Emergency Department administrators to optimize utilization of resources including utilization of medical personnel, such as nurses, and other medical resources, such as beds, medications, radiography, and the like. In addition the ability to effectively track the efficiency of patient care provision, being the ultimate goal of the Emergency Department, is a highly desirable, and as yet imperfectly met need. Thus, a system that allows hospital administrators to monitor the cumulative activity of a given department over a time period and assess staff and administrative efficiency is needed in the field.

Currently, some existing hospital tracking systems allow medical staff to enter and view information in a flowsheet format and organize general patient information in a manner that is useful for the particular medical setting. Other systems allow a user to define a particular set of parameters to be followed throughout the treatment. For example, U.S. Pat. No. 5,682,526 issued to Smokoff et.al. discloses a method, in a computer system under user control, for flexibly organizing, recording and displaying medical patient care information using fields in a flowsheet. The method allows a user to customize flow sheets and define parameters of medical procedures and values as needed by the particular health care facility. Further, the system allows a user to add results to the existing flowsheet from various tests conducted. However, the system disclosed and claimed in the '526 patent does not allow a user to track cumulative patient and/or physician activity, analyze treatment periods, control billing or monitor quality control. Further, there is no indication that this form of patient tracking could be adapted to optimize reimbursement of hospital expenditures keyed to insurance company policies.

U.S. Pat. No. 6,125,350 issued to Dirbas is directed to a method of providing a computer operated medical information log system comprising user defined input concerning medical procedures, routing of patients, attending physicians or residents, and codes for billing. In addition, the patent discloses a method of providing a medical information log system useful in tracking data in a surgical outpatient environment, for the purpose of at least one of the following: record keeping, outcome analysis, research, teaching, quality assurance, or billing. However, the '350 patent does not disclose or claim that the system may be adapted for general use by other hospital staff, i.e. nurse, manager or other staff, for the purpose of monitoring patient admission and discharge on a daily, monthly or yearly basis. Further, there is no indication in the '350 patent that the disclosed billing function could be adapted for use by a hospital manager in assessing hospital expenditures and reimbursement from insurance companies.

U.S. Pat. No. 5,812,984 issued to Goltra discloses a method for entering user defined medical information (e.g. patient history, test results, medical findings etc.), into an electronic patient chart, the primary purpose of which is to streamline the process of updating previously handwritten charts of those patients transferred between hospital departments. However, the method disclosed and claimed in the '984 patent does not teach or suggest how data electronically recorded within the patient charts could be subsequently used to evaluate department activity or increase the efficiency and accuracy of reimbursement for services rendered

U.S. Pat. No. 5,950,168 issued to Simborg is directed toward a collapsible flowsheet for displaying patient information in an electronic medical record. The purpose of this is to provide an improved user interface for use by a healthcare provider in maintaining and viewing information from an electronic medical record. However, the '168 patent, although disclosing and claiming a flowsheet to collect patient information, does not disclose an application of its flowsheet to optimize reimbursement from insurance companies for covered hospital expenditures. Further, there is no information disclosed in the '168 patent to indicate that the flowsheet may be adapted to evaluate cumulative patient or physician care data.

U.S. Pat. No. 5,760,704 issued to Giles discloses an electronic tracking system developed for use primarily in a hospital emergency room facility. This system expedites the handling and manipulation of patient information by electronically updating patient charts. However, the system disclosed and claimed in the '704 patent consists of multiple modules connected to multiple peripheral stations to allow simultaneous use by medical staff. As described, the system requires extensive hardware to operate which, in turn, necessitates a substantial financial investment by a purchaser. Since, the system as disclosed does not allow for statistical analysis to assess hospital billing efficiency or quality control, any benefit received from its use, would not solve the problem of receiving inadequate compensation for care provided, or ensure efficient utilization of hospital resources.

WO Patent No. 97/06498 issued to Kumagai, discloses a method for integrating and displaying various kinds of medical data collected at irregular intervals in a flowsheet, by doctors, nurses, laboratory personnel and other medical staff. The flowsheet lists parameters (e.g. blood sugar level, urine volume etc.) that medical personnel monitor over a time period (e.g hourly, daily, monthly etc.) for a given patient. The flowsheet allows for the collection of data from multiple patients and a comparison of changes in selected clinical and therapeutic data within a given time period for a particular problem. The primary function of this system is to allow medical personnel to monitor the progress of patients as they progress through treatment. Additionally, the invention may be used in long term medical studies or drug treatment evaluations. However, the method disclosed and claimed in the '498 patent does not teach or suggest how it could be adapted to allow hospital administrators to statistically analyze patient and physician activity throughout the period covering admission, treatment and discharge. Further, there is no indication that this method could be used to evaluate hospital billing efficiency as it relates to reimbursement of claims covered through insurance companies.

The above-described systems notwithstanding, no currently available system allows a user to define patient care parameters in a flowsheet format, track patient, physician, and other medical personnel activity from admission through discharge, and statistically analyze data from a given time period to increase hospital efficiency and optimize reimbursement by insurance companies. Thus, there is a need for such a system if hospitals are to continue to provide the high level of patient care that is expected and necessary while remaining financially solvent.

### SUMMARY OF THE INVENTION

The present invention is titled HOSPITAL EMERGENCY DEPARTMENT RESOURCE UTILIZATION AND OPTIMIZATION SYSTEM (hereinafter referenced as “HEDRUO”). The HEDRUO provides a method of tracking physician and patient activity within a hospital Emergency Department through user defined inputs, using a LOTUS® (or other flowsheet or database plafform) implemented flowsheet. Further, the system provides a method of collecting patient admission, care and discharge information in a flowsheet format that allows for subsequent statistical analysis of daily, monthly or yearly Emergency Department activity and efficiency tracking of resource utilization

In one preferred embodiment, a LOTUS® implemented flowsheet is generated containing the following daily data: patient information, department information, time by process, patient fate, and testing performed. Information collected daily is automatically transferred to another level of a LOTUS® implemented flowsheet to establish a cumulative monthly table of activity within the department. Monthly data is subsequently transferred to another LOTUS® implemented flowsheet to establish cumulative annual activity within a department. A user is able to create a sortable database organized in a hierarchical format, that permits subsequent analysis of selected data. Cumulative care data for a given time period is sorted by specific sections (e.g. Fast Track, Main, or Pediatric) within the Emergency Department and analyzed for trends in activity over a given period. In this manner, hospital administrators can retrospectively view activity over a time period and perform different statistical analyses to assess the overall operation of the department, or individual sections within the department and utilize the data to implement prospective resource optimization and efficiency enhancing procedures. Further, by monitoring the types of care provided, administrators can track revenue by doctor, patient, treatment or duration of visit. Additionally, by tracking patient care, administrators may assess utilization of consumable (e.g. fluids, wound dressings, medications etc.) and non-consumable (e.g X-ray, CAT scan, etc.) resources over a given time period. In this manner, the total costs associated with patient care can be calculated, accurate patient bills can be generated and complete records can be transmitted to insurance companies for proper reimbursement.

These and other advantages of the present invention will become apparent to those skilled in the art upon a reading of the following detailed description of the invention, and the claims appended hereto.

### BRIEF DESCRIPTION OF THE DRAWINGS

FIG. 1 is a diagram of a first embodiment of components of the programmable computer implemented HEDRU system of the present invnetion.

FIG. 2 is a diagram showing individual stand alone programmable computer implemented HEDRU system stations for each section of an Emergency Department.

FIG. 3 a diagram showing a simple network for connection of HEDRU system stations with other areas of a hospital.

FIG. 4a is a screen view of an Emergency Department daily patient report according to the present invention detailing typical categories found in a flowsheet format.

FIG. 4b is a screen view of an Emergency Department daily patient report department activity report according to the present invention detailing information collected from a single patient.

FIG. 5 is a screen view of an Emergency Department monthly total activity report according to the present invention.

FIG. 6 is a screen view of an Emergency Department cumulative patient distribution information chart for a four month period.

FIG. 7 is a screen view of an Emergency Department daily patient visit list showing time of arrival and departure distribution information.

FIG. 8a is a screen view of monthly statistical data regarding patient diagnosis/chief complaint for the Pediatric section of the Emergency Department.

FIG. 8b. is a screen view of monthly statistical data regarding patient diagnosis/chief complaint for all sections of the Emergency Department.

### DETAILED DESCRIPTION OF THE INVENTION

The present invention provides a method of tracking physician, patient and other medical personnel activity, and resource utilization within a hospital Emergency Department. A LOTUS® (or other flowsheet or database platform) implemented flowsheet is used to record patient admission, care and discharge information through user defined inputs. A method of collecting patient admission, care and discharge information in a flowsheet format that allows for subsequent statistical analysis of daily, monthly or yearly Emergency Department activity is also facilitated by this invention. The invention is directed to streamlining the provision of emergency care, optimization of reimbursement of hospital Emergency Department expenditures keyed to insurance company policies (e.g. Ambulatory Patient Codes, etc.), and optimization of Emergency Department resource utilization. By linking data collected over a given time period, the invention permits the generation of daily, monthly, annual or larger reports of department activities and resource utilization. This method allows retrospective tracking of these activities over a user-specified time period, and may be used in predictive modeling and efficiency analysis. Further, by monitoring the number and types of tests performed by medical staff, the system allows a user to track consumable supplies and assess the overall efficiency of resource utilization for an Emergency Department during a time period.

In use, by example a patient seen in any section of an Emergency Department will be provided with a number, an identification card, a bar-coded wrist band, or similar means to be identified and tracked by members of the medical staff. The medical staff member(s) assigned to the patient will record patient data in a flowsheet by clicking on the relevant cells (e.g. patient name, attending physician, diagnosis/chief complaint, time of arrival, visit and departure, tests performed etc.) and entering desired information. The system is set up to allow for the collection of information upon arrival or at a later time for those situations in which a patient is incommunicative and must first be stabilized due to catastrophic injury. Data can be manually collected from charts and entered into cells on a flowsheet corresponding to a given patient, or can be automatically updated by linking an identification device placed on the patient upon arrival with a computer system. In this manner, collection of data is conducted in the least intrusive manner to allow attending medical staff to concentrate on patient care. The software system, contained on a Floppy disk, can be used to program individual computers, all existing computers in a given area, or a network server accessible by medical staff in different sections of the Emergency Department involved in providing care to a given patient. This flexibility is desirable because over a given shift, medical personnel often move between sections of the Emergency Department according to patient needs and activity of a section.

In this way, attending staff can update the fields in a flowsheet with information relevant to their activity. Thus, the ability to open flowcharts and update data at any given station within the Department will facilitate more accurate collection of patient information The fields in the flowsheet may be locked after entry to avoid multiple inputs for the same data, thus avoiding duplication of effort, and thereby increasing staff efficiency. Further, the fields in the flowsheet may be linked by user defined formulae to represent specific billing codes (e.g. Ambulatory Patient Code), that will aid hospital administrators in identifying reimbursable expenditures and generating accurate billing invoices to send to insurance companies.

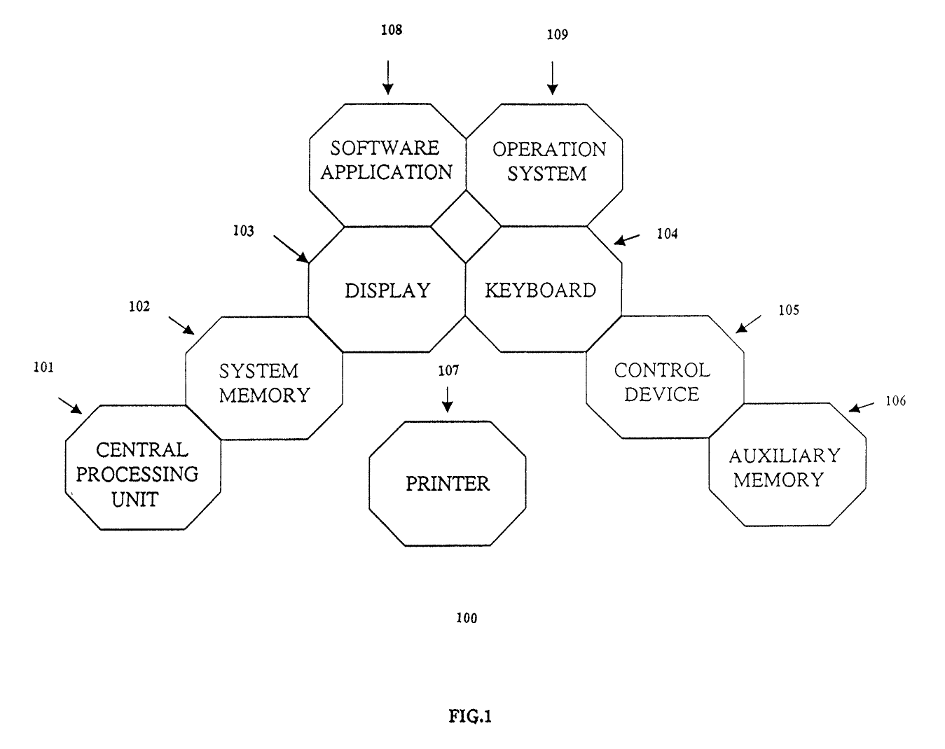

FIG. 1 is a diagram of a first embodiment of the programmable computer implemented system generally indicated at 100. In a preferred embodiment, the computer system comprises a central processing unit (CPU) 101, a system memory 102, a display device 103, a keyboard 104, a control device 105, an auxiliary memory 106 (e.g. hard disk, floppy disk, CD-ROM, Zip Drive etc.), and a printer 107. The CPU is loaded with a software application 108, and an operating system 109. The software application is preferably LOTUS® 1,2,3, but may be any commercially available database platform that is capable of interfacing with an operating system to produce an interactive, updateable flowsheet for the input of user defined patient and hospital resource utilization data. The software application must allow for the creation of user-defined fields in a flowsheet, sorting of data by category, and performance of numerical and statistical calculations according to user-defined formulae. Preferably, the software application would allow for display of data in multiple formats such as, for example, flowsheet, bar graphs, pie charts, line graphs etc. The operating system employed will depend on whether the system functions as a stand alone unit, or is networked to other computers. Examples of some operating systems compatible with stand alone systems include DOS, WINDOWS®, OS/2, and others. Networked systems would require more powerful operating systems such as, for example, UNIX, WINDOWS NT, OS/3, LINUX or others.

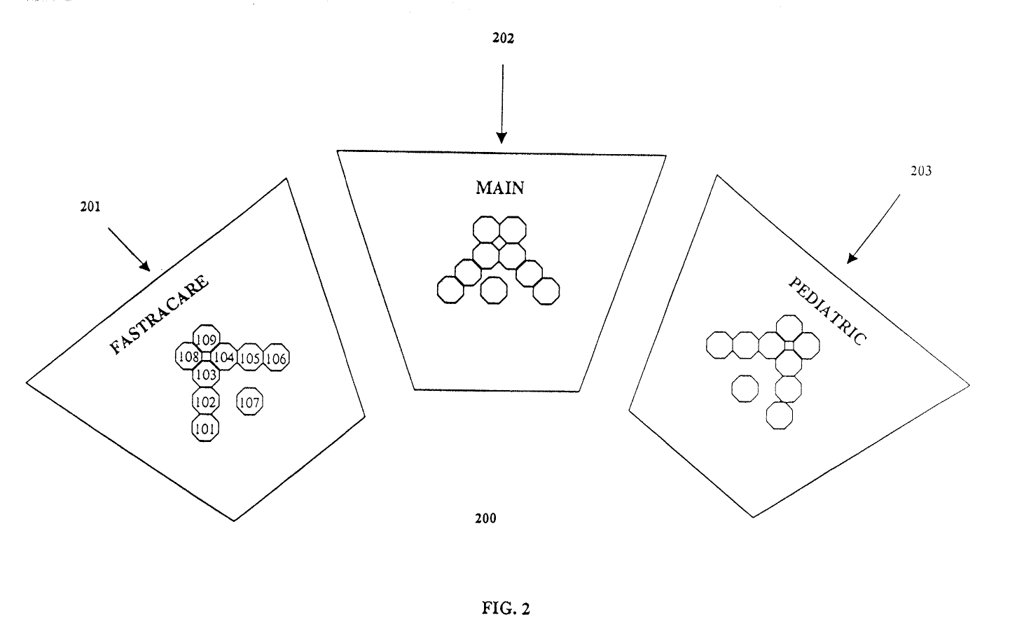

FIG. 2 is a diagram of showing stand alone computer system stations generally indicated at 200 used in each department. Each station has one or more modules which have one or more computer systems set-up similar to that described in FIG. 1 As shown, the Fastracare department module 201, Main Department module 202, and Pediatric care department module 203, are designed to be independent of one another. For example, the Fastraccare Department module has a central processing unit (CPU) 101, a system memory 102, a display device 103, a keyboard 104, a control device 105, an auxiliary memory 106 and a printer 107. The CPU is loaded with a software application 108, and an operating system 109. Designed in this fashion, data from one section is kept independent of data from another section. Thus, users in one section may not order tests from outside their section department, or go to another section to retrieve information. This design may be desirable in very large Emergency Departments, where the individual sections operate essentially independent of one another and resources are separately accounted for.

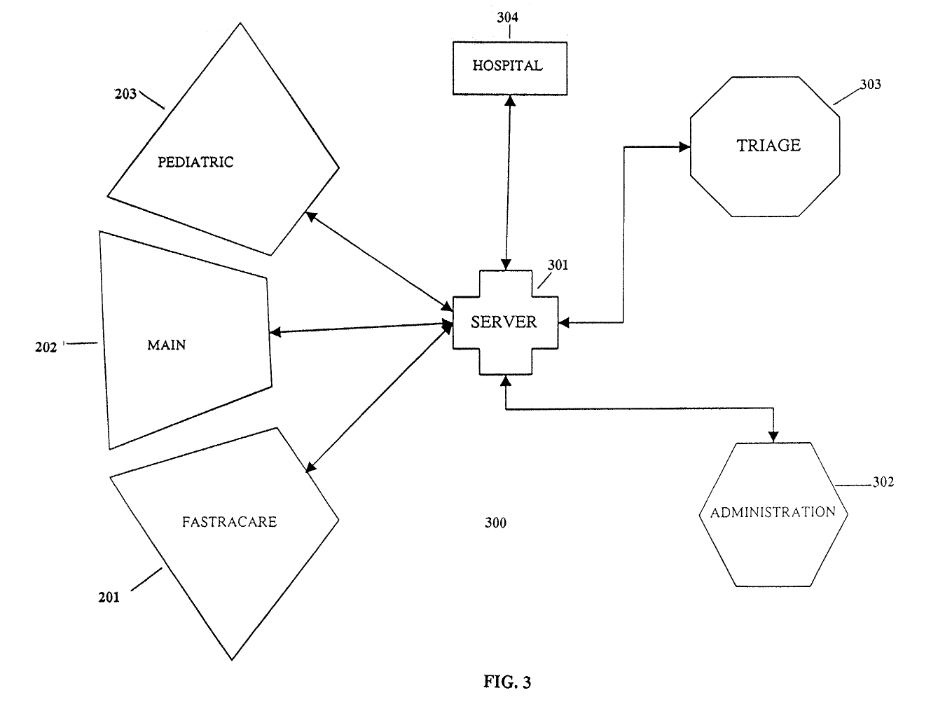

FIG. 3 is a diagram showing a simple network, generally indicated at 300, linking all sections of the Emergency Department with one another. In a preferred embodiment multiple stations are networked together as shown. An applications program 108 (see FIG. 1), such as, for example, Lotus 1,2,3® and an operating system 109 (see FIG. 1), such as, for example, Windows NT® are loaded onto a main server 301. Members of a medical staff may access the applications program through computers systems at a Fastracare section terminal 201, Main section terminal 202 or a Pediatric Care section terminal 203 loaded onto the server to create new patient information flowsheets, or modify data contained in existing flowsheets according to the particular needs of the section. Information is stored on the server and may be accessed by anyone logged onto a computer linked to the network. Of course, identification codes or other means of restricting access to medical personnel is preferred. This set-up allows a user to update a flowsheet to accommodate new information regardless of where they are in an Emergency Department. For example, this set-up allows a nurse at a triage station 303 to evaluate turnaround time in each section of the Emergency Department by viewing the progress of each patient being treated. This will help the nurse coordinate an often chaotic waiting room by providing patients with a more accurate prediction of when they will be seen by medical staff, thereby increasing efficiency of patient care. If the hospital has a mainframe server, it may be desirable to load the application program onto this server to allow medical staff access to patient charts from any location within a hospital 304, or through an internet portal from outside the hospital. This design would be particularly desirable in environments where patients are removed from the Emergency Department for testing, such as, for example, to obtain an MRI scan, and subsequently returned to the Emergency Department, or where physicians or other staff members make rounds between similarly owned hospitals in a given area. By providing greater access to these flowsheets, staff members can input new data, or update existing data at a time or place where it is most convenient. Further, by networking the various departments in this manner, an administrator may download data from one or more departments to his or her office computer, make instantaneous checks on consumable and non-consumable resource utilization prior to placing orders, examine trends in activity, evaluate efficiency of one or more sections or staff members, or view other information of interests, without having to go to each section of the Emergency Department to download the information.

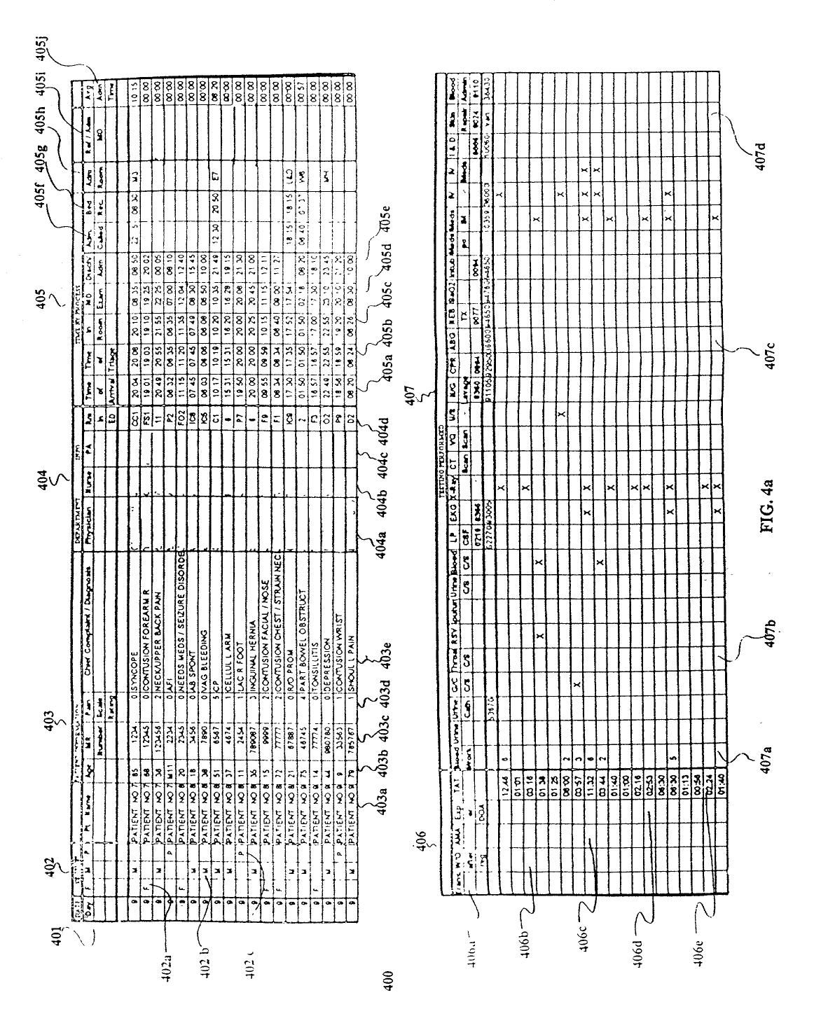

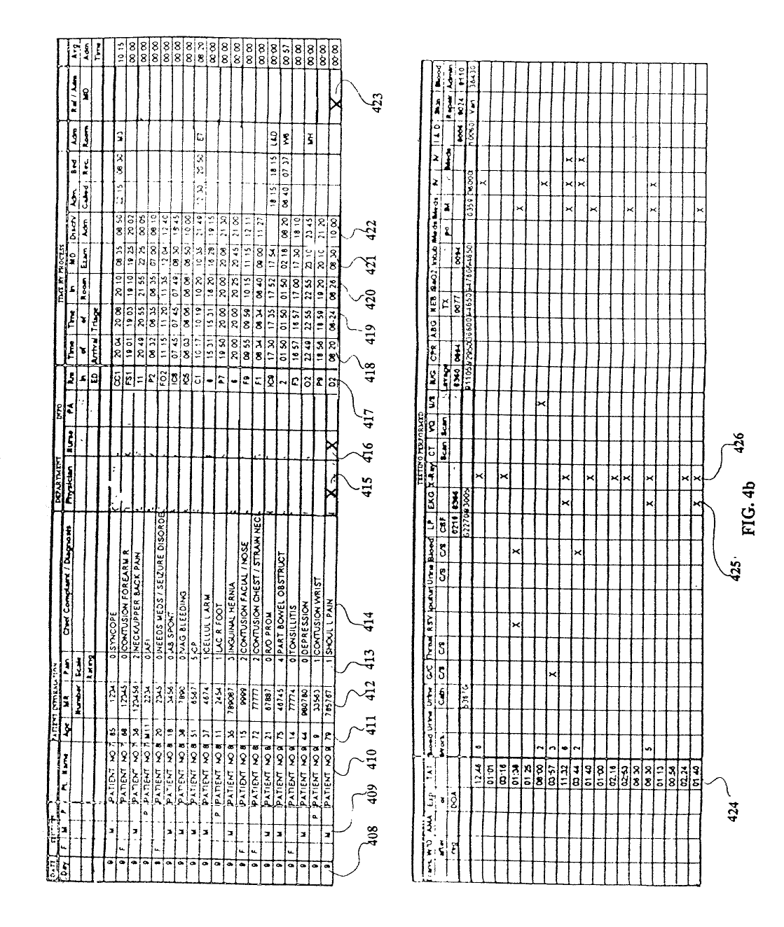

FIG. 4a is a screen display of an Emergency Department daily patient report on a LOTUS® 1,2,3 implemented flowsheet, generally indicated at 400. A user views and interacts with a display 400 through use of a control device 105 (see FIG. 1) such as, for example, a mouse, and inputs data using a keyboard, bar code reader, touch screen inputs, voice activated commands or other similar input device 104 (see FIG. 1) by activating a desired display element as is well known in the art. In one embodiment, a daily display 400 is divided into seven major categories: Day of the month 401, section within the Emergency Department 402, patient information 403, department information 404, time by process 405, patient fate 406, and testing performed 407. Each major category may be further subdivided into sub-categories depending on user input. As displayed, the major category section 402 is sub-divided into minor categories: Fast Track 402a, Main 402b and Pediatrics 402c. Patient information 403 is further subdivided into sub-categories: patient name 403a, age 403b, medical records number 403c, pain scale rating 403d, and chief complaint/diagnosis 403e. Department information 404 is divided into sub-categories: physician 404a, nurse 404b, physician assistant 404c, and room 404d. Time by process 405 is divided into subcategories: time of arrival 405a, time of triage 405b, time in room 405c, time of medical exam 405d, time of discharge or admission 405e, time admissions called 405f time bed received 405g, admitting room 405h, referring or admitting physician 405i, and average admitting time 405j. Patient fate 406 is divided into sub-categories: transferred patients 406a, patient who left without treatment 406b, patients who left against medical advice (AMA) 406c, patient who died in the department, or were dead on arrival (Exp/DOA) 406d, and total average time in Emergency Department 406e. Testing performed 407 is divided into a myriad of subcategories depending upon the regimen of tests required for each patient. Some representative examples of procedures commonly performed in an Emergency Department include blood work 407a, throat culture (C/S) 407b, arterial blood gas (ABG) 407c, and skin repair 407d. Those skilled in the art will recognize that a wide divergence in the file layout and categories and sub-categories of data tracked may be accommodated by the presently disclosed system according to the needs of a particular administrator, Emergency Department, or other medical facility, without departing from the heart of this invention. However, after many years as an administrator of a major American Emergency Department, the present inventor has found that the layout and categories of data herein defined provides a very useful system for tracking data relevant to hospital Emergency Department initial information. In use, by way of example, a user defines the particular information contained within each section by highlighting the specific cell, activating the cell by clicking a mouse, striking a key and typing or otherwise entering the desired parameter.

FIG. 4b is the same chart placed herein for explanation of terminology and may be read in the following way. On Feb. 9, 2000 408 in the Main section 409 of the Emergency Department, a patient 410, age 79 411, was checked into the Emergency Department and assigned a medical records number (765767) 412. The patient was assessed as having a value of 1 on pain scale rating 413. Patient was diagnosed with having shoulder pain 414. The patient was examined by a physician 415 and a nurse 416 in room D2 417. The patient arrived at the hospital at 08:20 418, was triaged at 08:24 419, and placed into a room at 08:26 420. The patient was provided with a medical exam at 08:30 421 and was discharged 10:00 422 The patient had been referred to the Emergency Department by another doctor 423. The total time the patient was attended to was 01:40 424. The patient had two tests run, an EKG 425 and an X-ray 426 prior to discharge.

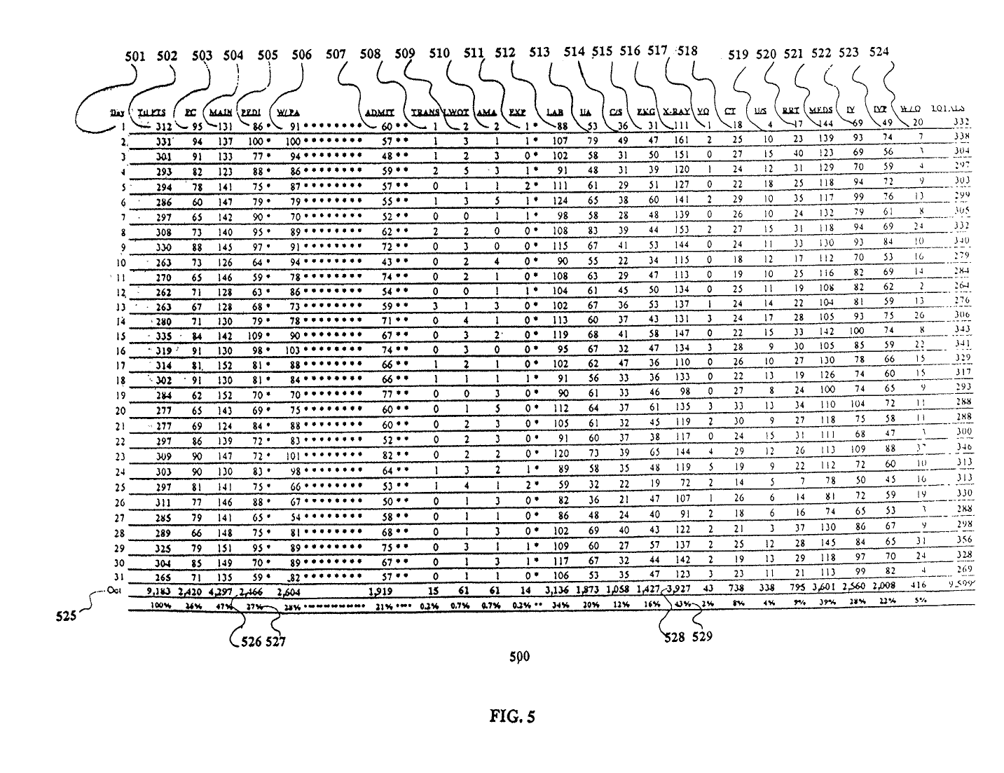

FIG. 5 is a screen display of the Emergency Department monthly activity report generally indicated at 500 according to the present invention. The display is divided into categories representing cumulative data for each day of a month. By way of example, data on the instant display may be read as follows: On the 1st day of October 501, 312 total patients 502 were seen at the Emergency Department. Of those 95 went to the Fastracare section 503, 131 were seen in the Main section 504 and 86 were seen in the Pediatrics section 505. 91 of the 312 were W/PA 506. 60 patients were admitted to the hospital 507, 1 patient was transferred to another hospital 508, 2 patients left without treatment (LWOT) 509 2 patients left against medical advice (AMA) 510, and 1 patient died in the Emergency Department 511. Of the 312 patients seen by an examining physician, the following tests were ordered: 88 labs 512, 53 urinalysis 513, 36 gonorhea culture sensitivity tests (C/S) 514, 31 electrocardiograms (EKG) 515, 111 X-rays' 516, 1 Lung and perfusion scan (VQ) 517, 18 computer tomography scans (CT's) 518, 4 ultrasound exams (U/S) 519, 17 renal replacement therapies 520, 144 medications 521, 69 intravenous medications (IV) 522, 49 IV Persantine-thallium stress tests (IVP) 523, and 20 patients were seen but not treated (W/O) 524. Total cumulative values for each parameter, along with calculations of the percentage each parameter relative to the whole are listed at the base of the table. For example, of the 9,183 patients that were treated in all Emergency Department sections in the month of October 525, 2,466 526 or 27% 527 were examined in the Pediatric section. Also, of all patients examined, 3,927 528 or 43% 529 had an X-ray ordered as part of their treatment. Patients who were examined in the Emergency Department, but whom did not have any tests ordered are also listed 530. As can be seen, this data provides a very convenient, useful and informative snapshot of patient treatment, resource utilization and efficiency information for any given time period of operation of the Emergency Department.

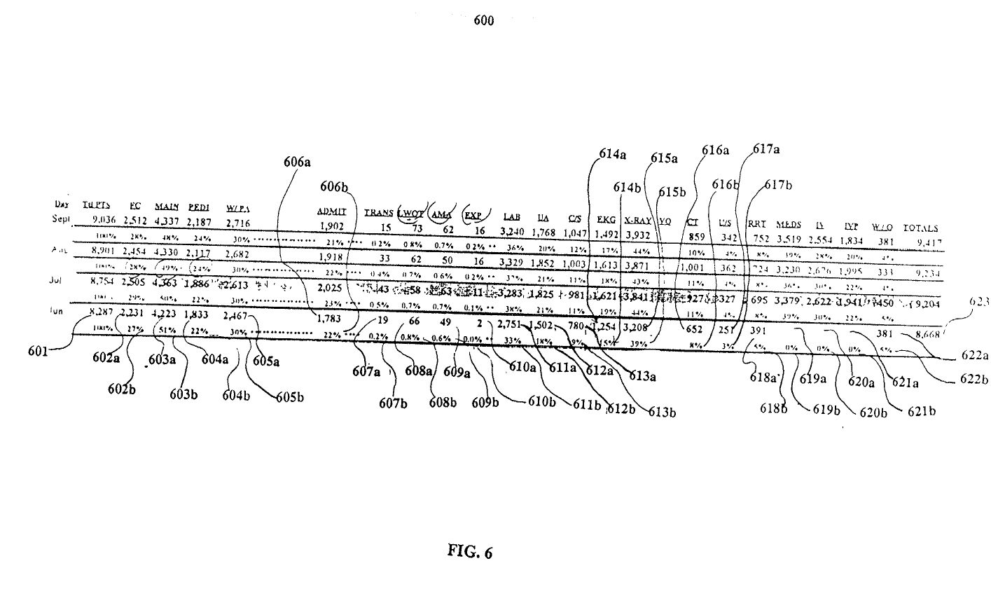

FIG. 6 is a screen display showing compressed cumulative data of daily activity within an Emergency Department, generally shown at 600 separated by month over a four month period. Arranged in this manner, the data can be analyzed to assess trends in activity over a number of months. An administrator can track the total number of patients seen in each of the three or more, or less, as needed sub-departments, of the Emergency Department (e.g. Fastracare, Main, or Pediatrics), the number of patients that were admitted, transferred or that left without treatment, and the total number and type of tests administered in the Emergency Department over a given time period. Further, the display shows the percentage calculations relating to the amount of any one activity relative to the whole. By way of example, data on the instant display may read in the following way. For the month of June, 2000 a total of 8,287 patients 601 were seen in the Emergency Department. Of those, 2,231 602a or (27%) 602b were examined in the Fastracare section, 4,223 603a or (51%) 603b were examined in the Main section, and 1,833 604a or 22% 604b were examined in the Pediatric section. Out of 8,287 total patients seen 601, 2,467 605a or 30% 605b were W/PA. For the month, 1783 606a or 22% 606b of patients seen were admitted, 19 607a or 0.2% 607b were transferred, 66 608a or 0.8% 608b left without treatment (LW/OT), 49 609a or 0.6% 609b left against medical advice (AMA), and 2 610a or <0.0% 610b died while in the Emergency Department (Exp/DOA). Of the patients seen, attending physicians ordered 2,751 labs 611a or 33% 611b (read as 33% of all patients seen had a lab test ordered as part of their care), 1,502 urinalysis (UA) 612a or 18% 612b, 780 throat culture sensitivity tests (C/S) 613a or 9% 613b, 1,254 electrocardiograms (EKG) 614a or 15% 614b, 3,208 X-Rays 615a or 39% 615b, 652 computer tomography scans (CT) 616a or 8% 616b, 251 ultrasounds U/S 617a or 3% 617b, 391 renal replacement therapies 618a or 5% 618b, 0 Medications 619a or 0% 619b, 0 intravenous medications (IV) 620a or 0% 620b, and 0 Persantine-thallium stress tests (IVP) 621a or (0) 621b. Of all patients who were observed, 381 622a or 5% 622b were not treated. This provides for the differential between all patients coming into the emergency department 8,668 623 and all patients coming into the department that received some type of treatment 8,287 601. Once again, as can seen, resource utilization over any described time frame is available according to this system for the use of an administrator of hospital resource utilization.

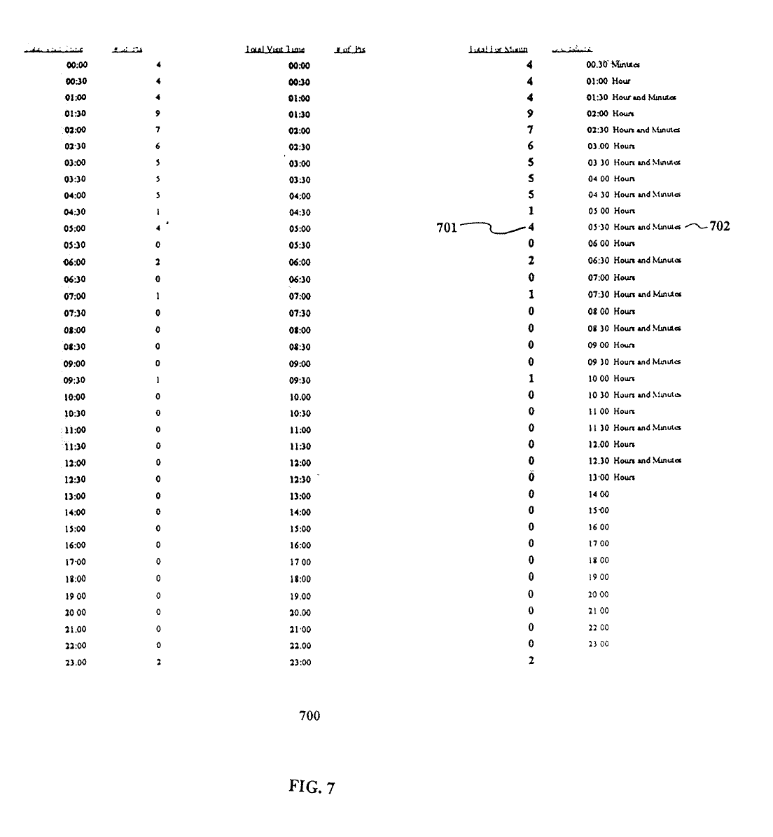

FIG. 7 is a screen display of the daily distribution information displaying patient total visit time, partitioned into thirty minute or any other preferred user-defined time intervals. The display shows how long each patient was in the Emergency Department from the moment of arrival to the moment of discharge or admittance. This data can be used to assess efficiency of patient treatment over the course of a time period, such as, for example, a day, a month, a year etc. The time period may be changed according to user defined inputs. By way of example, the instant display showing one twenty-four hour period 700 can be read as follows: on the day under review, a total of 60 patients were seen in the Emergency Department of the hospital. Of these, four patients 701 were discharged within five hours and thirty minutes of arrival at the hospital 702. As displayed, the flowsheet provides a useful snapshot of the time patients spent in an Emergency Department. The flowsheet may also be displayed in graphical format to aid interpretation. This allows administrators to assess how efficient a unit is compared to others. In this way, procedures may be implemented to increase turn-around time for patients. Also, when broken down by time intervals, the flowsheet provides a clear view of trends in patient total visit time throughout a 24 hour period. Hospital administrators can use this information to assess staffing requirements (e.g. how many staff members are required for a given shift), as well as monitor staff efficiency over a time period.

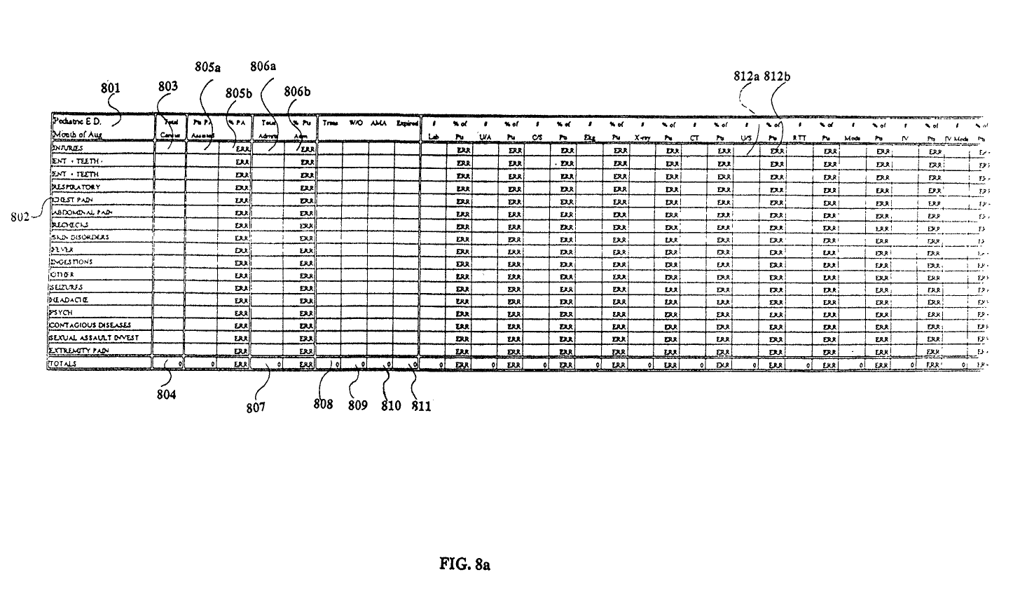

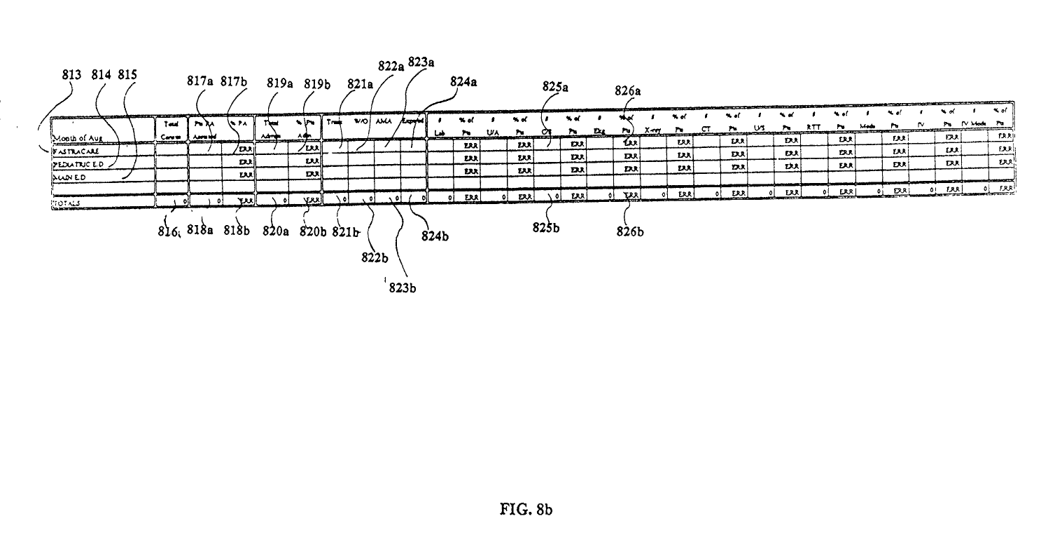

FIG. 8a is a screen display showing the monthly statistics of the diagnosis/chief complaint of each patient seen in the month of August in the Pediatric section of the Emergency Department. The display shows each defined injury treated in the department within the month, along with a total number of patients seen in that section of the Emergency Department for the same injury over the course of a month. The display also shows which level of staff, (e.g physician, physician assistant, nurse etc.) treated a patient with a particular injury, the fate of the patient, and what tests were run related to a particular injury. Numerical totals for a given category as well as calculated percentages of that activity as related to the whole activity are also provided. This set-up provides a user with the ability to track activity in a single section of the Emergency Department over the course of a month, by staff, type of injury or tests run. By totaling the activity and calculating percentages of each activity against the whole, hospital administrators can address the particular needs of a section with regard to supplies and equipment, track the efficiency of medical staff and generate patient bills that accurately reflect the costs associated with treatment. The instant display is divided into a myriad of user defined categories. As displayed the categories include: section of the Emergency Department 801, type of injury 802, total census for same injury 803, total census for all injuries 804, patients who were assisted by physician assistant 805a, along with calculations of the percentage of the total number of patients who were treated, in part, by a physician assistant 805b, total admissions 806a along with a calculation of the percentage of total patients who were ultimately admitted to the hospital 807, number of patients transferred to other medical facilities 808, number of patients who left without treatment 809, the number of patients who left the Emergency Department against medical advice 810, and the number of patients who died while in the Emergency Department 811. Monthly statistics on tests administered, along with a calculation of the percentage of a test administered, relative to all tests given in a monthly period are also provided. Examples of these include the number of ultrasounds (U/S) given 812a and the percentage of these tests as represented against the whole 812b. All of these analyses are facilitated by sorting data fields as required for a desired analysis. The data may be sorted by category or sub-category and may be summarized by writing formulae within the software code that, when activated, will prompt a CPU to calculate and summarize data contained within a field.

FIG. 8b is a screen display showing a summary of monthly totals and statistics by section of the Emergency Department. A condensed, monthly total of all activity for each day of the month from each of the three departments, Pediatrics, Fastracare and the Main Emergency Department is presented. The display, similar to that shown in FIG. 8a, serves essentially the same function to that disclosed in FIG. 8a, except that it shows total values. As displayed, this summary contains the total number of patients seen in each sub-department of the Emergency Department, the total number of injuries treated in Fastracare 813, Pediatric Department 814, and Main Department 815, along with a cumulative total for all three departments 816. Additional information includes the number of patients treated, in part, by a physician assistant 817a in each section, and the total of all patients treated 817b, the percent of all patients treated by physician assistant in each section 818a and the percentage of all patients treated by a physician assistant out of the total number of patients treated 818b, the total number of admissions for each section 819a, along with the percent of the total number of admissions 819b out of all patients seen in that section; the total number of patients admitted to the hospital from all sections of the Emergency Department 820a along with the percentage of patients admitted for all sections relative to all patients examined 820b. Additional data includes number of transfers from each section 821a along with total number of transfers from all sections 821b; number of patients who left without treatment 822a from each section along with totals for all sections 822b; number of patients who left against medical advice in each section 823a along with the total for all sections 823b; number of patients who died in each section of the Emergency Department 824a along with a total number of patients who died in the Emergency Department 824b, The total number of each tests ordered per section 825a, along with the total number of that test ordered in all departments 825b, The percentage of patients receiving a specific test in each section 826a along with the total percentage of patients getting that test 826b. By linking monthly total activity for all departments in one condensed flowsheet, administrators are provided with a clear, easily understood picture of all physician and patient activity within all sections of an Emergency Department over an extended time period, that relate to resource utilization and reimbursement of expenditures tied to insurance company policies. Likewise, by calculating the percent occurrence of a given activity associated with a given department, a user can monitor trends within a given section. The ability to retrospectively analyze trends in activity will allow hospital administrators to better predict future needs of the Department, develop more efficient means to provide high quality care for patients, and gain better control over remuneration for services rendered.

While the present disclosure and the attached figures provide specific embodiments of the Hospital Emergency Department Resource Utilization and Optimization System, those skilled in the art will appreciate from this disclosure that variations, modifications and equivalents of the specific elements suggested by the present disclosure come within the scope of this invention. Hence, the embodiment here is intended to be illustrative, rather than restrictive. Variations and changes to flowchart, data structure, analysis, computer design etc. may be made without departing from the spirit and scope of the present invention. For example, the entire system may be set up along an external network to allow geographically distinct hospitals owned by the same organization to be linked together. The system may be adapted to save patient records in an archived format for long term record storage. The system may be set up to automatically calculate resource utilization and place supply orders accordingly, thereby allowing employees to concentrate on other areas of management and patient care to increase efficiency. For example, a code could be attached to a specific test such that when a user indicates that such a test has been performed, a defined number of, for example, syringes, x-ray film, catheters etc, are automatically deducted from an inventory and recorded for future ordering. Alternatively, because the system allows a user to create categories at will, the system could be used as an educational training device to familiarize new employees with routine practices in the Emergency Department. Similarly, publicly funded hospitals could use the system to create charts showing typical activity level of a unit to persuade appropriate governing bodies to increase funding. The system could be used to create and print customized flowchart sheets for distribution to rural hospitals not utilizing a computerized network. Also, the system could be adapted for use with developing technology such as hand held computers, such as, for example, 3-COM Palms, Palm-sized PCs (WinCE), and other personal digital assistant devices or any other remote device capable of displaying a medical information flowchart. A remote, mobile system accessible at any location would likely facilitate efficiency in a hospital Emergency Department. Data recorded on such devices could be downloaded to a mainframe through wiring, disc exchange, infra-red remote transmission or other means. The software application and operating programs could be loaded onto a CDrom or similar device, or may be directly downloaded from an internet site.

Accordingly, the scope of this invention should not be construed as being limited to the specifics of the detailed disclosure and best mode disclosed herein.

What is claimed is:

1. A method of tracking activity and resource utilization within a hospital emergency department comprising:
a. generating a user-defined medical information database representable in a flowsheet format in a programmable computer system, said flowsheet containing an array of interactive updatable cells for storing user entered medical data;
b. inputting data related to patient treatment, medical staff activity, and resource use into user defined categories within said cells of said flowsheet;
c. storing said data in user-defined, sortable databases;
d. retrieving user-defined from said sortable databases and performing statisitcal analysis on data to assess efficiency of medical staff activity, patient care and resource utilization over a given time period; and
e. generating reports containing said analyzed data

2. The method of claim 1, wherein said medical data is selected from the group comprising day, location within Emergency Department, patient information, department information, time by process, treatment time, patient fate, and testing performed.

3. The method of claim 2, wherein said day corresponds to the day of the month a given patient was treated.

4. The method of claim 2, wherein said location within Emergency Department is selected from the group comprising Fastracare, Main, and Pediatric sections.

5. The method of claim 2, wherein said patient information data is selected from the group comprising patient name, patient age, medical routing number, chief complaint/diagnosis.

6. The method of claim 2, wherein said department information data is selected from the group comprising: physician, physician assistant, nurse, other medical staff and room number.

7. The method of claim 2, wherein said time by process data is selected from the group comprising time of arrival, time of triage, time in room, time of medical exam, time of discharge or admission, time admission department called, time bed received, admitting room, referring/admitting physician, total admission time.

8. The method of claim 2, wherein said treatment time data is selected from the group comprising transfers, patients who left without treatment, patients who left facility against medical advice, patients who expired while in the emergency room, total average time.

9. The method of claim 2, wherein said testing performed data is selected from the group comprising blood work, urine, culture, electrocardiogram, X-ray, lung and perfusion scan, computer tomography scan, ultrasound, arterial blood gas, lumbar puncture, cardio-pulmonary resuscitation, medications, renal therapy, blood administration, intubation, medications.

10. The method according to claim 2, wherein tests performed within said testing performed category are marked by a user to indicate that the test has been performed.

11. The method of claim 2 adapted to track patient turnaround time in an Emergency Department comprising inputting time of arrival of each patient monitoring progress of patient as they move from triage to treatment to admission or discharge, and recording final total visit time.

12. The method of claim 1 adapted for analysis of activity over a time period wherein said data is compressed by selecting data from a given time period; prompting a central processing unit (CPU) to calculate and display the total values for a given category over a given time period; and receiving from the CPU a compressed summary of total activity for all categories over a time period.

13. The method of claim 12, wherein said compressed summary may be further subdivided by percentage of a given activity relative to total activity.

14. The method of claim 1, wherein statistical summaries of user-defined patient information within a given section of an Emergency Department are performed.

15. The method according to claim 14, wherein said statistical analysis is conducted on data selected from the group comprising day, location within Emergency Department, patient information, department information, time by process, treatment time, patient fate, testing performed.

16. The method according to claim 14, wherein said statistical summaries correspond to activities selected from the group comprising Fastracare, Main and Pediatric sections of the Emergency Department.

17. The method of claim 14, adapted to maintaining in a flowsheet format, statistical summaries of patient information within the all sections of the Emergency Department

18. A programmable computer system for use in tracking activity and resource utilization within a hospital Emergency Department, comprising
a. a central processing unit; a system memory; a display device; an input device; a control device; an auxiliary memory, and a printer;
b. said central processing unit enabled with a software application capable of generating an interactive, updatable electronic flowchart for collection and analysis of medical data;
c. said central processing unit further enabled with an operating system capable of interfacing with said software application;
d. said flowchart organized into a plurality of cells containing a plurality of user defined medical category labels, wherein each of said category labels indicates a user defined name for a category of medical information collected from patients treated in a hospital Emergency Department;
e. said system memory capable of storing data in user-defined, sortable databases;
f. said display device capable of displaying data collected in a flowsheet format;
g. said control device capable of directing activity of said software application;
h. said input device capable of inputting patient data into user defined categories of said flowsheet;
i. said auxiliary memory capable of retrieving said data in said flowsheet format, saving said data in a portable memory, and retrieving said data in the same or another computer;
j. said printer capable of generating reports containing selected data from Emergency Department database.

19. The system of claim 18, wherein said software application is selected from the group comprising LOTUS®, EXCEL® and combinations thereof.

20. The system of claim 18, wherein said operating system is selected from the group comprising Macintosh, DOS, Windows, Windows NT, OS/2, OS/3, and Unix.

21. The method of claim 18, wherein said input device is selected from the group consisting of a keyboard, bar code reader, touch screen, voice recognition and combinations thereof.

22. The method of claim 18, wherein said system memory is a system hard drive.

23. The computer system of claim 2, wherein said auxiliary memory is selected from the group comprising a floppy disk, CDRom, internet memory storage device, network drive, or server.

24. A method in a programmable computer system for designing and maintaining the contents of a sortable patient medical information database comprising:
a. generating an electronic flowsheet containing a plurality of interactive, updatable cells, said cells capable of receiving user-defined medical data;
b. inputting user-defined medical information collected over a time period into said cell, wherein said information is displayed in a subsets of user-modifiable information in conjunction with each patient;
c. linking information contained within one group of cells, with information contained within one or more other groups of cells, through user-defined algebraic equations, such that tabulated results from one group of cells form part of the calculation of one or more other groups of cells;
d. creating sortable patient information databases through user defined inputs of selected data; said data linked through user defined equations such that evaluation of one set of data allows for comparison with another set of data; and
e. storing said information within a computer memory for later retrieval.

25. A medical information database in a programmable computer system for use in tracking activity and resource utilization in a hospital Emergency Department.

26. The database of claim 25, wherein said information is representable in a flowsheet format.

27. The database of claim 25, wherein said database is organized according to a daily, monthly, or yearly hierarchy of activity.

28. The database of claim 25, wherein said database is divided into a first level, second level and third level.

29. The database of claim 25, wherein each subsequent level of said hierarchy summarizes all data from the preceding level.

30. The medical information database of claim 25, wherein said first level of said hierarchy comprises the total daily physician/patient activity within all categories defined by said user.

31. The database of claim 18, wherein said second level of said hierarchy comprises numerical totals for each category defined for each day of the month.

32. The medical information database of claim 25, wherein said third level of said hierarchy comprises the total monthly physician/patient activity for a year for each category defined by a user.

33. A method of using medical information stored in a computer system to track hospital billing efficiency and insurance reimbursement comprising
a. analysis of user defined medical data stored in a sortable medical information database within a computer system;
b. said information sorted according to activity related to patient admission, treatment, and discharge over a user defined time period;
c. comparison of expenditures linked to one or more user-defined activities within a section of an Emergency Department over a given time period, with actual reimbursement obtained from insurance companies for invoices associated with said activity.
d. statistical analysis of billing invoices related to department operating expenses over a given time period to evaluate hospital billing efficiency.

34. The method according to claim 33, wherein said data analyzed is selected from the group comprising, number of patients treated over a time period, tests ordered, supplies used in conjunction with tests ordered, number of patients treated in a given section over a time period, ratio of medical staff to patients treated, time per procedure, total visit time, number of tests accepted or rejected for reimbursement by insurers, and combinations thereof.

35. The method according to claim 33, wherein said time period is a given day, a given month, a given year or a plurality of years

36. A improved patient medical information database for use in a hospital setting, wherein the improvement comprises:
a. means for tracking cumulative patient and physician activity, and resource utilization over a time period;
b. means for statistically analyzing data associated with hospital billing efficiency and quality of patient care; and
c. means to optimize reimbursement from insurance companies for covered hospital expenditures.
